(19) United States
(12) Patent Application Publication
(10) Pub. No.: US 2006/0214009 A1
(43) Pub. Date: Sep. 28, 2006

(54) Nonvolatile storage apparatus

(75) Inventors: Atsushi Shikata, Nishitokyo (JP); Yasuhiro Nakamura, Tachikawa (JP); Chiaki Kumahara, Kodaira (JP)

Correspondence Address: Miles & Stockbridge P.C.;Suite 500, 1751 Pinnacle Drive, McLean, VA, 22102, US

(73) Assignee: Renesas Technology Corp.

(21) Appl. No.: 11/389,250

(22) Filed: Mar. 27, 2006

(30) Foreign Application Priority Data
Mar. 28, 2005 (JP) 2005-091034

(51) Int. Cl. G06K 19/06

(52) U.S. Cl. 235/492

(57) ABSTRACT

A nonvolatile storage apparatus which is not deadlocked even if a data processing section gets out of control during a power-on reset is provided. The nonvolatile storage apparatus includes a first semiconductor device having a data processing section capable of executing instructions and an external interface section, and a second semiconductor device controlled by the first semiconductor device. The external interface section, upon detecting that an operating supply voltage supplied from outside the nonvolatile storage apparatus has reached or exceeded a prescribed voltage, responds to an initialization command supplied from outside the nonvolatile storage apparatus and makes the data processing section start reset exception processing. After the reset exception processing is completed, the external interface section does not respond to the initialization command. When a prescribed state is reached during the reset exception processing, the external interface section again responds to the initialization command and makes the data processing section start the reset exception processing. The prescribed state is a state in which, during the reset exception processing, the data processing section has become or is anticipated to become out of control.

### CROSS-REFERENCE TO RELATED APPLICATION

The present application claims priority from Japanese patent application No. 2005-091034 filed on Mar. 28, 2005, the content of which is hereby incorporated by reference into this application.

### BACKGROUND OF THE INVENTION

The present invention relates to a memory card and a nonvolatile storage apparatus such as a multiple function card which is a memory card having a microcomputer for IC card formed thereon. It relates to technology effectively applicable to nonvolatile memory cards such as a memory card operated at low voltage, for example, using an operating supply voltage of 1.8 V or a dual voltage memory card compatible with operating supply voltages of, for example, 1.8 V and 3.3 V.

A nonvolatile memory card which can be removably inserted in a card slot of a host device is, when it is inserted in the card slot, supplied with operating power supply from a host system. The nonvolatile memory card has a card controller and a flash memory. The card controller has, for example, a microcomputer as a data processing section to execute instructions. When the card controller is powered on, the microcomputer is reset by a power-on reset. When, for example, the operating power supply that has been turned on reaches or exceeds a minimum operating voltage, a reset terminal of the microcomputer is set at a low level and, as a result, internal initialization of the microcomputer starts. When an initialization command is given by the host system, the reset terminal of the microcomputer is set at a high level and, as a result, the microcomputer starts reset exception processing. As part of the reset exception processing, the microcomputer accesses the flash memory and reads information such as a memory card ID. The flash memory and the card controller differ in manufacturing process. This is because the flash memory requires high voltage when rewriting information stored therein. Hence, they also differ in minimum voltage at which they are operational (minimum operating voltage). Generally, the card controller is lower in minimum operating voltage than the flash memory. There are, therefore, cases in which, when the supply voltage reaches the minimum operating voltage of the card controller and the microcomputer starts power-on reset processing, the minimum operating voltage of the flash memory has not been reached. In such a state, reading, by the microcomputer, of ID information from the flash memory may result in a read error or a data error.

Technology disclosed in the patent document 1 includes an arrangement for the following procedure: unique data is written on a flash memory beforehand; when the unique data is correctly read out at a power-on reset, normal processing is performed; if the unique data is not correctly read out, the microcomputer is put in a sleep state; subsequently, with the microcomputer in a sleep state, when an initialization command is received again, the inside of the microcomputer is initialized and reset exception processing is performed again.

Technology in which a watchdog timer is used to detect running out of control of a program in a microcomputer and then cause resetting operation to be performed is described in the patent document 2.

[Patent document 1] Japanese Unexamined Patent Publication No. 2003-85508

[Patent document 2] Japanese Unexamined Patent Publication No. Sho 60 (1985)-27038

### SUMMARY OF THE INVENTION

The measure disclosed in the patent document 2 is aimed at, when program execution in a microcomputer in normal operating condition gets out of control, detecting and recovering from such an out-of-control state. The measure disclosed in the patent document 1 is based on the assumption that a microcomputer is operated at a normal operating voltage. Therefore, when the microcomputer is not supplied with a normal operating voltage and, as a result, a reset signal is set at a low level causing the microcomputer to be instructed to perform reset exception processing, the microcomputer itself gets out of control. In such a state, the microcomputer cannot even be put in a sleep state. Moreover, a flag to indicate a state in which, in response to an initialization command, the microcomputer has been instructed to perform power-on reset processing is provided in a card controller. This is to prevent undesired reset exception processing from being performed if an initialization command is inputted while a memory card is operating normally. In such an arrangement, however, unless the flag is reset, even responding to an initialization command issued by a host device is impossible. When the microcomputer gets out of control, no matter how many times the host device issues the initialization command to the memory card, the memory card being unable to return a response to the host device remains in a busy state. In such a state, the memory card will have to be re-inserted in the card slot before it is operational again.

The above state occurs particularly when a low operating supply voltage is used. Take a case where the operating supply voltage is 3.3 V nominal, for example. The minimum operating voltage of the flash memory is 2.5 V and that of the microcomputer is 2.0 V, so that the difference between the two minimum operating voltages is relatively large. Assume that, in this case, the minimum operating voltage of the memory card is 2.5 V. Even if it is taken into account that the accuracy (2.50±0.10 V) of the voltage detection circuit has been affected by factors in the manufacturing process, there is practically no possibility of the operating supply voltage being lower than the minimum operating voltage of the microcomputer when reset exception processing is performed. If the operating supply voltage is 1.8 V nominal, the minimum operating voltage of the flash memory is 1.6 V and that of the microcomputer is 1.5 V, so that the difference between the two minimum operating voltages is extremely small. In such a case, the minimum operating voltage of the memory card is usually 1.5 V. If, in such a case, the accuracy (1.50±0.10 V) of the voltage detection circuit has been largely changed by being affected by factors in the manufacturing process, the microcomputer may be instructed to perform reset exception processing while the operating supply voltage is lower than the minimum operating voltage of the microcomputer.

The above possibility also exists when using, with a low-potential power supply of 1.8 V, a dual voltage memory card compatible with both of the operating supply voltages of 3.3 V and 1.8 V.

An object of the present invention is to provide a nonvolatile storage apparatus and a semiconductor device which are not deadlocked even if their data processing section gets out of control during a power-on reset processing.

The above and other objects, and novel features of the present invention will become apparent from the description in the present specification and the attached drawings. Representative ones of the inventions disclosed in the present application are briefly described in the following.

[symbol] 1 [symbol] A nonvolatile storage apparatus according to the present invention includes a first semiconductor device (3) having a data processing section (8) capable of executing instructions and an external interface section (7), and a second semiconductor device (4) controlled by the first semiconductor device. The external interface section, upon detecting that an operating supply voltage supplied from outside the nonvolatile storage apparatus has reached or exceeded a prescribed voltage, responds to an initialization command supplied from outside the nonvolatile storage apparatus and makes the data processing section start reset exception processing. After the reset exception processing is completed, the external interface section does not respond to the initialization command. When a prescribed state is reached during the reset exception processing, the external interface section again responds to the initialization command and makes the data processing section start the reset exception processing. The prescribed state is a state in which, during the reset exception processing, the data processing section has become or is anticipated to become out of control.

With the above arrangement made, even if the data processing section gets out of control when starting the reset exception processing in response to the initialization command, the external interface section can again respond to the initialization command to have the reset exception processing started. The data processing section is not deadlocked even if it gets out of control during a power-on reset processing. Even if the initialization command is issued after the reset exception processing is normally terminated, undesired resetting of the nonvolatile storage apparatus is prevented.

In an embodiment of the present invention, the external interface section has a timer circuit (21). The timer circuit starts counting in synchronization with starting of the reset exception processing and detects an elapse of a time-out period longer than a time required to complete the reset exception processing. When an elapse of the time-out period is detected by the timer circuit, the external interface section again responds to the initialization command and causes the reset exception processing to be started. With this arrangement made, when the data processing section gets out of control, the timer circuit is timed out, so that the external interface section can again responds to the initialization command to have the reset exception processing started. Stopping the timer circuit operation when the reset exception processing is completed can prevent undesired giving of a response to the initialization command if issued after completion of the reset exception processing.

In another embodiment of the present invention, the nonvolatile storage apparatus has a specified circuit (24) which includes programmed information for specifying a time-out period of the timer circuit. The specified circuit may be composed of, for example, a fuse program circuit or an aluminum master slice. The timer circuit may be composed of a counter circuit including flip-flop circuits connected in series.

In still another embodiment of the present invention, the data processing section has a data processor (10), a ROM (32), and a decision circuit (31). The ROM holds a program for the reset exception processing. The decision circuit can detect, at least within a time required to complete the reset exception processing, disagreement between information read out from a prescribed address of the ROM and an anticipated value. When the disagreement is detected, the external interface section again responds to the initialization command and causes the reset exception processing to be started. With this arrangement made, when the operating supply voltage for the data processing section has not reached the minimum operation guaranteed voltage of the data processing section at instructing of execution of the reset exception processing, a read access to the ROM results in a data error causing the disagreement to be detected. Hence, the external interface section can again respond to the initialization command to have the reset exception processing to be started. The prescribed address of the ROM may be, for example, the starting address of the program for the reset exception processing.

In a still another embodiment of the present example, time-up control by the timer circuit and decision control for data read from the ROM may both be used.

In a still another embodiment of the present invention, the external interface section further includes a first flag and a second flag. The first flag is changed from a first state to a second state when the initialization command supplied from outside the nonvolatile storage apparatus is received for the first time after the operating supply voltage supplied from outside the nonvolatile storage apparatus has reached or exceeded a prescribed voltage. The second flag is changed from a first state to a second state when the prescribed state is reached during the reset exception processing. It is changed from the second state to the first state when the reset exception processing is subsequently completed. When both the first flag and the second flag are in the first state or when both the first flag and the second flag are in the second state, the external interface section responds to the initialization command and makes the data processing section start the reset exception processing. When the first flag is in the second state and the second flag is in the first state, the external interface section does not allow the data processing section to start the reset exception processing even if the initialization command is given.

In a still another embodiment of the present invention, the second semiconductor device is a flash memory and the first semiconductor device is a memory card controller which performs access control and external interface control for the flash memory. Furthermore, the nonvolatile storage apparatus includes a microcomputer for IC card connected to the memory card controller.

[symbol] 2 [symbol] The nonvolatile storage apparatus seen from another standpoint includes a first semiconductor device and a second semiconductor device controlled by the first semiconductor device. The first semiconductor device, upon detecting that an operating supply voltage supplied from outside has reached or exceeded a prescribed voltage, responds to an initialization command supplied from outside and starts reset exception processing. After the reset exception processing is completed, the first semiconductor device does not respond to the initialization command. When a prescribed amount of time has elapsed after the reset exception processing was started, the first semiconductor device again responds to the initialization command and starts the reset exception processing.

The nonvolatile storage apparatus seen from still another standpoint includes a first semiconductor device and a second semiconductor device controlled by the first semiconductor device. The first semiconductor device, upon detecting that an operating supply voltage supplied from outside has reached or exceeded a prescribed voltage, responds to an initialization command supplied from outside and starts reset exception processing. After the reset exception processing is completed, the first semiconductor device does not respond to the initialization command. When, before the reset exception processing is completed, a read access error is detected in making a read access to a memory storing a program for the reset exception processing, the first semiconductor device again responds to the initialization command and starts the reset exception processing.

In an embodiment of the present embodiment, the second semiconductor device is a flash memory, and the first semiconductor device is a memory card controller which performs access control and external interface control for the flash memory.

The nonvolatile storage apparatus seen from still another standpoint includes a first semiconductor device having a data processing section and a second semiconductor device controlled by the first semiconductor device. The first semiconductor device, upon detecting that an operating supply voltage supplied from outside has reached or exceeded a prescribed voltage, responds to an initialization command supplied from outside and starts reset exception processing by the data processing section. After the reset exception processing is completed, the first semiconductor device does not respond to the initialization command. When a state in which the data processing section has become or is anticipated to become out of control is reached during the reset exception processing, the first semiconductor device again responds to the initialization command and starts the reset exception processing by the data processing section.

[symbol] 3 [symbol] A semiconductor device according to the present invention includes a data processing section capable of executing instructions and an external interface section. It is formed on a semiconductor substrate. It, upon detecting that an operating supply voltage supplied from outside has reached or exceeded a prescribed voltage, responds to an initialization command supplied from outside and starts reset exception processing by the data processing section. After the reset exception processing is completed, the semiconductor device does not respond to the initialization command. When a prescribed amount of time has elapsed after the reset exception processing was started, the semiconductor device again responds to the initialization command and starts the reset exception processing by the data processing section.

Another semiconductor device according to the present invention includes a data processing section capable of executing instructions and an external interface section. It is formed on a semiconductor substrate. It, upon detecting that an operating supply voltage supplied from outside has reached or exceeded a prescribed voltage, responds to an initialization command supplied from outside and starts reset exception processing by the data processing section. After the reset exception processing is completed, the semiconductor device does not respond to the initialization command. When a state in which the data processing section has become or is anticipated to become out of control is reached during the reset exception processing, the semiconductor device again responds to the initialization command and starts the reset exception processing by the data processing section.

Effects of representative ones of the inventions disclosed in the present application are briefly described in the following.

A nonvolatile storage apparatus such as a memory card or a semiconductor device such as a memory card controller can be prevented from being deadlocked even if its data processing section gets out of control during a power-on reset.

### BRIEF DESCRIPTION OF THE DRAWINGS

FIG. 1 is a block diagram showing, as a first example of a memory card, a configuration in which a deadlock at power-on reset is prevented using a timer circuit.

FIG. 2 is an explanatory diagram showing an operating voltage range of the memory card using a supply voltage of 1.8 V nominal.

FIG. 3 is a flowchart showing a flow of controlling power-on reset processing performed in the memory card.

FIG. 4 is a block diagram showing, as a second example of a memory card, a configuration in which a decision circuit 31 is used instead of the timer circuit to prevent the deadlock.

FIG. 5 is a block diagram showing, as a third example of a memory card, a configuration which includes both the timer circuit shown in FIG. 1 and the decision circuit shown in FIG. 4 for use in preventing the deadlock.

FIG. 6 is a block diagram showing, as a fourth example of a memory card, a configuration in which the configuration shown in FIG. 1 is applied to a dual voltage memory card.

FIG. 7 is an explanatory diagram showing an operating voltage range of the memory card using a supply voltage of 3.3 V nominal.

FIG. 8 is an explanatory diagram showing an operating voltage range of the dual voltage memory card, the voltage range covering the range shown in FIG. 2 and the range shown in FIG. 7 combined.

FIG. 9 is an explanatory diagram showing, as an operating range of the dual voltage memory card using a high potential power supply, a microprocessor operating voltage range which is more limited than shown in FIG. 8.

FIG. 10 is a block diagram showing a fifth example of a memory card further having a microcomputer for IC card.

### DETAILED DESCRIPTION OF THE PREFERRED EMBODIMENTS

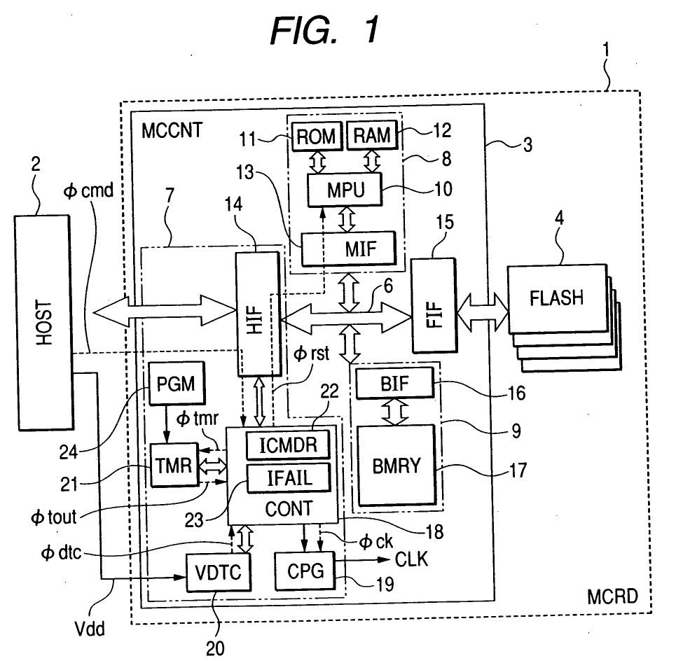

FIG. 1 shows an example of a memory card. A memory card (MCRD) 1 shown in FIG. 1 is, for example, a MultiMedia Card, that is, a nonvolatile memory card complying with the MultiMedia Card specification (“MultiMedia Card” is a registered trademark of Infineon Technologies AG. It will be hereinafter referred to as “MMC”). The memory card 1 is composed as a file memory operated in response to a memory card command which is issued from a host device (HOST) 2 and which is compliant with the MMC specification.

The host device 2 is, for example, a mobile phone, personal digital assistance (PDA), personal computer, audio playback (and recording) device, still camera, video camera, automatic teller machine, street-corner terminal, or settlement terminal.

The memory card 1 includes an internal memory card controller (MCCNT) 3 and an internal flash memory (FLASH) 4, each being composed in a discrete semiconductor integrated circuit chip, formed on a memory card substrate. Plural external connection terminals of the memory card 1 are exposed on the memory card substrate. The flash memory 4 is a memory chip using a semiconductor memory as a memory medium. Data can be read and written from and to the flash memory 4 using flash memory commands. The configuration of the flash memory 4 will not be described in detail here, but it includes, for example, many nonvolatile memory cells having floating gates as charge storage areas and nonvolatile memory cells having insulating charge storage areas made of silicon nitride. The threshold voltage of a nonvolatile memory cell increases when electrons are selectively injected into its charge storage area, and the threshold voltage decreases when electrons are discharged from the charge storage area. Increasing the threshold voltage is referred to, for example, as writing, and decreasing the threshold voltage is referred to, for example, as erasing. Writing and erasing requires high voltage. The flash memory 4, for example, has a charge pump type booster circuit. It uses the booster circuit to boosts a supply voltage so as to generate the high voltage needed to perform writing or erasing.

Though not shown in the figure, the MMC has seven external terminals including a power supply terminal, a clock input terminal, a command input/output terminal, a data input/output terminal, a ground terminal, and a chip selection terminal. The MMC specification specifies two operation modes, that is, MMC mode and SPI mode, for MMC1. The external terminals are used differently between the two operation modes.

The memory card controller 3 has an external interface section 7 interfaced to the host device 2, a data processing section 8, a buffer memory section 9, and a flash memory interface circuit (FIF) 15 connected to the flash memory 4, all of which are connected to a bus 6.

The data processing section 8 has a microprocessor (MPU) 10, a ROM 11, a RAM 12, and a processor interface (MIF) 13. The MPU 10 has an instruction control section which controls instruction execution sequences and decodes instructions and an instruction execution section which executes decoded instructions by accessing operands and performing operations according to the instructions. The ROM 11 holds instructions to be executed by the MPU 10. The RAM 12 is used as a work area for the MPU 10. The MIF 13 connects the bus 6 to the MPU 10. When accessing the FLASH 4, the MPU 10 issues an access command to the FLASH 4 via the FIF 15.

The buffer memory section 9 has a buffer interface circuit (BIF) 16 and a buffer memory (BMRY) 17. The MPU 10 temporarily stores write data transferred from the HOST 2 in the BMRY 17. When issuing a write command to the FLASH 4, the MPU 10 supplies the write data stored in the BMRY 17 to the FLASH 4. When supplying data stored in the FLASH 4 to the HOST 2, the MPU 10 temporarily stores the data read out from the FLASH 4 in the BMRY 17. The MPU 10 sequentially transfers the data stored in the BMRY 17 to the HOST 2.

The external interface section 7 has a host interface circuit (HIF) 14, a host interface control circuit (CONT) 18, a clock pulse generation circuit (CPG) 19, a voltage detection circuit (VDTC) 20, a timer circuit (TMR) 21, and a program circuit (PGM) 24. When the CONT 28 accepts a memory card command given by the host device 2, it returns an acknowledgment to the host device 2. The CONT 28 interprets the memory card command it has accepted and issues an interrupt determined according to the content of the command to the MPU 10. The MPU 10 performs processing in accordance with the interrupt. The CPG 19 generates an internal clock signal CLK of the memory card controller 3.

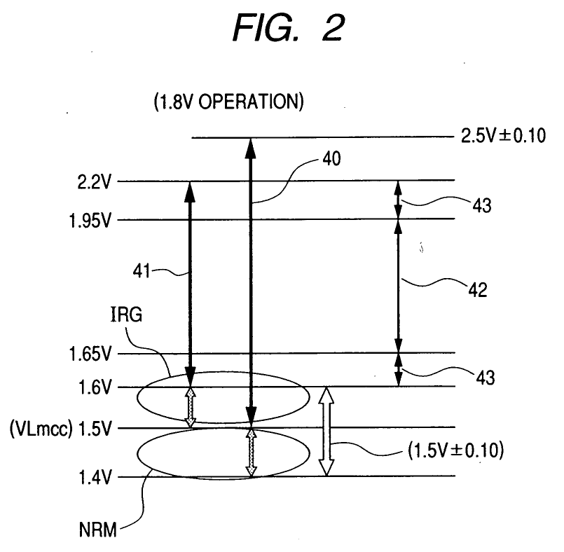

The operating supply voltage for the memory card 1 is, as shown in FIG. 2, 1.8 V nominal. The operating voltage ranges, subjected to no particular restrictions, of the memory card controller 3 and the flash memory 4 are as denoted by reference numerals 40 (1.5 V to 2.5 V) and 41 (1.6 V to 2.2 V), respectively. A reason why the operating voltage ranges 40 and 41 are different is that the semiconductor manufacturing processes used to manufacture the memory card controller 3 and the flash memory 4 are different. The operating voltage range, subjected to no particular restrictions, recommended for the memory card 1 is as denoted by reference numeral 42 (1.65 V to 1.95 V). Reference numeral 43 denotes marginal operating voltage ranges (0.5 V or more). The voltage detection circuit 20 checks whether or not a supply voltage Vdd supplied to the memory card 1 from outside is 1.5 V or more, that is, whether or not the Vdd is higher than the minimum voltage (VLmcc) of the voltage range 40. This check is done with a voltage detection accuracy of ±0.10 V. Based on the voltage detection accuracy, when the supply voltage Vdd is in a range IRG, the memory card controller 3 operates normally. When the supply voltage Vdd is in a range NRM, normal operation of the memory card controller 3 is not guaranteed. An error occurring in the range IRG becomes obvious in the MPU 10. This is because the MPU 10 operates at high speed in synchronization with the clock signal. Operations of other circuits than the voltage detection circuit are dependent on static states of the respective circuits, so that, for practical purposes, such circuits are not considered to cause errors even when the supply voltage is in the range IRG. Variations in the manufacturing process for the memory card controller 3 are considered to affect the voltage detection accuracy more than they affect logic circuit portions. This is because the voltage detection circuit 20 uses an analog circuit configuration to detect the minimum voltage (VLmcc). The reason why the voltage detection circuit 20 is to detect the minimum voltage (MLmcc) is as follows. A configuration for preventing a deadlock during a power-on reset exception processing, being described later, is adopted, so that, even if a detection error occurs, the power-on reset exception processing can be performed again. To facilitate functioning of such an arrangement, processing to make the memory card operate is to be started as early as possible. Next, how the deadlock is prevented will be described.

The host interface control circuit 18 gives, in response to a command from the host device 2, a corresponding interrupt signal (including an exception processing request signal) to the MPU 10. A reset signal φrst is an interrupt signal outputted by the host interface control circuit 18. When the operating power supply is turned on and the reset signal φrst goes low, the inside of the MPU 10 is initialized in terms of hardware. When the reset signal φrst subsequently goes low, so-called resetting is canceled and the MPU 10 executes the power-on reset exception processing.

The timer 21 is composed of a counter circuit made of plural flip-flop circuits connected in series. It detects elapse of a time-out period which is longer than the time required to execute the power-on reset exception processing. When a timer control signal φtmr outputted from the host interface control circuit 18 is asserted, the timer circuit 21 starts counting operation. When a count corresponding to an elapse of the time-out period is reached, the timer circuit 21 outputs a time-out signal stout to the host interface control circuit 18. If the timer control signal φtmr is negated in the course of the counting operation, the timer circuit 21 stops counting and it is then initialized. The program circuit 24 is a circuit where information specifying the time-out period of the timer circuit is programmed. It is composed of, for example, an aluminum master slice or a fuse program circuit. The timer circuit 21 is arranged such that the number of flip-flop circuits connected in series up to an output node for outputting the time-out signal φtout can be changed based on the information programmed in the program circuit 24. The time-out period is longer when the number of flip-flop circuits connected in series as described above is larger. The time-out period may be determined, in cases where an aluminum master slice is used, by changing the photomask depending on the manufacturing process or, in cases where a fuse program circuit is used, by determining the state of the fuse program depending on characteristic data obtained as a result of device testing. If it is not necessary to strictly determine the time-out period, the program circuit 24 is not required.

When the memory card 1 is inserted in the host device 2, the supply voltage Vdd starts being supplied to the memory card 1. When the voltage detection circuit 20 detects that the supply voltage vdd has reached or exceeded the minimum voltage VLmcc, it asserts a detection signal φdtc to the host interface control circuit 18. When the detection signal φdtc is asserted, the host interface control circuit 18 asserts a clock control signal φck causing the CPG 19 to output the clock signal CLK. The clock signal CLK is supplied to the MPU 10 and other clock synchronous circuits. The host interface control circuit 18 has an initialization command reception flag (a first flag) ICMDR and an initialization failure flag (a second flag) IFAIL. The initialization command reception flag ICMDR is changed from a reset state to a set state when the initialization command is received from the host device 2 for the first time after the detection signal φdtc is asserted. The initialization failure flag IFAIL is changed from a reset state to a set state when the time-out signal φtout is asserted. It is returned from the set state to the reset state when the reset exception processing is completed. Processing for returning the initialization failure flag IFAIL to the reset state may be performed, for example, at the same time as when the MPU 10, upon receiving the initialization command, returns a response to the host device 2. When the initialization command φcmd is received from the host device 2, the host interface control circuit 18 refers to the initialization command reception flag ICMDR and the initialization failure flag IFAIL. At this time, if the initialization command reception flag ICMDR and the initialization failure flag IFAIL are both in the reset state or both in the set state, the host interface control circuit 18 instructs, in response to the initialization command, the MPU 10 to perform the reset exception processing. Even if the MPU 10 is given, the host interface control circuit 18 does not allow the MPU 10 to start the reset exception processing if the initialization command reception flag ICMDR is in the set state whereas the initialization failure flag IFAIL is in the reset state.

When the detection signal φdtc is asserted, the host interface control circuit 18 sets the reset signal φrst low, thereby instructing the MPU 10 to initialize itself. The host interface control circuit 18 referring to the flags ICMDR and IFAIL detects when the initialization command φcmd is received from the host device 2 for the first time after the detection signal φdtc has been asserted. It then sets, after elapse of at least a delay time required to initialize the MPU 10 in terms of hardware, the reset signal φrst high, thereby instructing the MPU 10 to perform the reset exception processing. At the same time, it asserts the timer control signal φtmr. When the reset exception processing is completed, the MPU 10 negates the timer control signal φtmr and resets the flag IFAIL. Subsequently, the MPU 10, after confirming that the flash memory 4 can be accessed normally, reads ID information from the flash memory 4 and makes initialization based on the ID information read out from the flash memory 4. The MPU 10 then returns a response for the initialization command to the host device 2 and returns to the main routine. This enables the memory card 1 to perform memory operation in response to a command subsequently received from the host device 2. When, on the other hand, the time-out signal φtout is asserted, the flag IFAIL is reset. When this occurs, obviously, the reset exception processing has not been terminated normally. No response for the initialization command is therefore returned to the host device 2. The host device 2 then gives the initialization command φcmd to the MPU 10 again. In this state, with the flag IFAIL having been reset, the host interface control circuit 18 sets the reset signal φrst low thereby instructing the MPU 10 to make initialization. The host interface control circuit 18 can make the MPU 10 perform the reset exception processing again by, after elapse of at least the delay time required to initialize the MPU 10 in terms of hardware, asserting the reset signal φrst and the timer control signal φtmr. This process can be repeated until the supply voltage Vdd reaches a required voltage value, so that occurrence of a state where the MPU 10 is deadlocked during power-on reset processing causing the memory card to become nonoperational at all can be prevented.

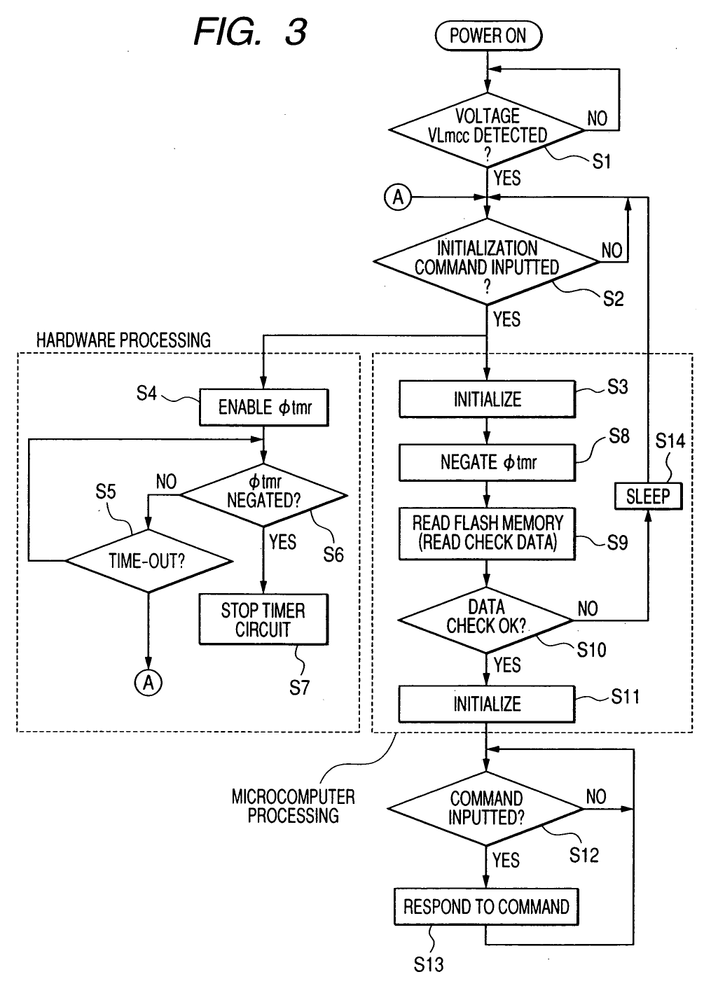

FIG. 3 shows a flow of power-on reset control performed in the memory card 1. When the memory card 1 inserted in a card slot of the host device 2 is powered on, the voltage detection circuit checks whether or not the supply voltage Vdd has exceeded the voltage VLmcc (S1). When it is determined that the supply voltage Vdd has exceeded the voltage VLmcc, issuance of the initialization command is waited for (S2). When the initialization command is issued, the MPU 10 is made to execute reset exception processing (S3) and the timer circuit 21 is activated (S4). The timer circuit 21 starts counting (S5). When interrupted, the timer operation is stopped (S6, S7). When a time-out period elapses, the processing returns to the state (S2) where issuance of the initialization command is waited for. When the reset exception processing is completed, the MPU 10 negates the timer control signal φtmr (S8). The MPU 10 then makes a read access to a prescribed address of the flash memory 4 (S9) and determines whether or not anticipated check data and the read data agree (S10). When the data agree, ID data is read out from the flash memory 4, initialization necessary to access a file in the flash memory is made (S11), and finally a response for the initialization command is returned to the host device 2. As a result, the memory card 1 enters a state where a command from the host device 2 is waited for (S12). The memory card 1 is made operational after responding to a command (S13). If the result of data checking made in step S10 is no good, the MPU 10 executes a sleep instruction to stop the processing (S14). The MPU 10 put in a sleep state is activated when an interrupt or exception processing is requested. In the present arrangement, the MPU 10 resumes operation when the host device 2 issues the initialization command again and execution of the reset exception processing is instructed by the interface control circuit 18.

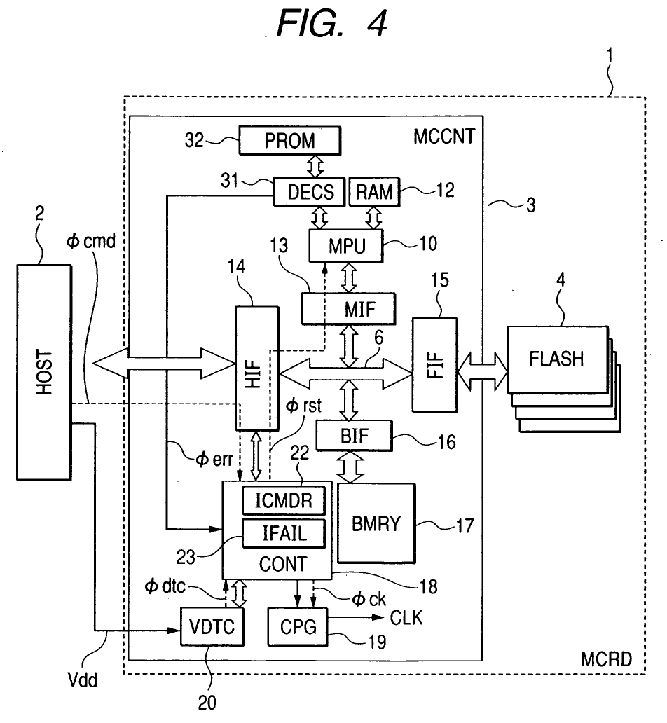

FIG. 4 shows a second example of a memory card. The memory card shown in FIG. 4 differs from the memory card shown in FIG. 1 in that, to prevent the above-described deadlock, a decision circuit (DECS) 31 is used instead of the timer circuit 21. Also, an electrically rewritable programmable ROM (PROM) 32 which may be a flash memory or an EEPROM is used instead of the mask ROM 11. The PROM 32, like the ROM 11, holds a program for the reset exception processing. The decision circuit 31 can check, at least within the time required to complete the reset exception processing, whether or not information read out from a prescribed address of the ROM agrees with an anticipated value. If they are found disagreeing with each other, the decision circuit 31 asserts a detection signal φerr. The prescribed address of the PROM may be, for example, a leading address of the reset exception processing program. When the detection signal φerr is asserted, the host interface control section 18 responds, by performing the same control operation as done when the time-out signal φtout is asserted, to the initialization command again thereby causing the reset exception processing to be started. Though not described in detail here, when the detection signal φerr is asserted, resetting of the flag IFAIL is controlled in the same way as done when the time-out signal φtout is asserted. In this arrangement, too, if, when execution of the reset exception processing is instructed, the supply voltage for the MPU 10 has not reached a minimum operation guaranteed voltage thereof, a read access to the PROM 32 results in a data error causing a disagreement to be detected, as described above, between the information read out and the corresponding anticipated value. In such an event, the host interface control section 18 can respond to the initialization command again to cause the reset exception processing to be started, so that deadlock of the MPU 10 can be prevented. In other regards, the configuration shown in FIG. 4 is the same as the configuration shown in FIG. 1, so that its detailed description is omitted here.

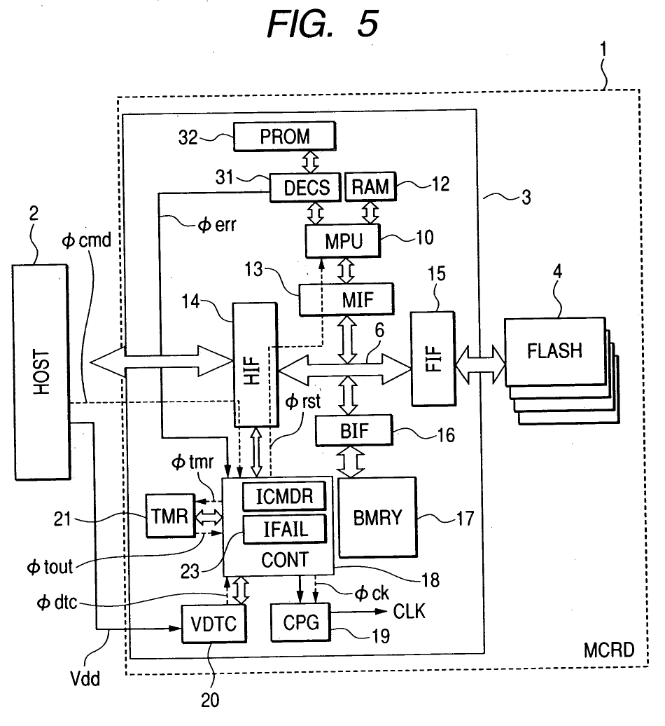

FIG. 5 shows a third example of a memory card. The memory card shown in FIG. 5 has both the timer circuit 21 shown in FIG. 1 and the decision circuit 31 shown in FIG. 4 for use in preventing the deadlock. In this configuration, when the detection signal φerr is asserted, operation of the timer circuit 21 is also stopped and it is initialized. The accuracy of error detection at power-on is higher with this configuration than with the configurations shown in FIGS. 1 and 4.

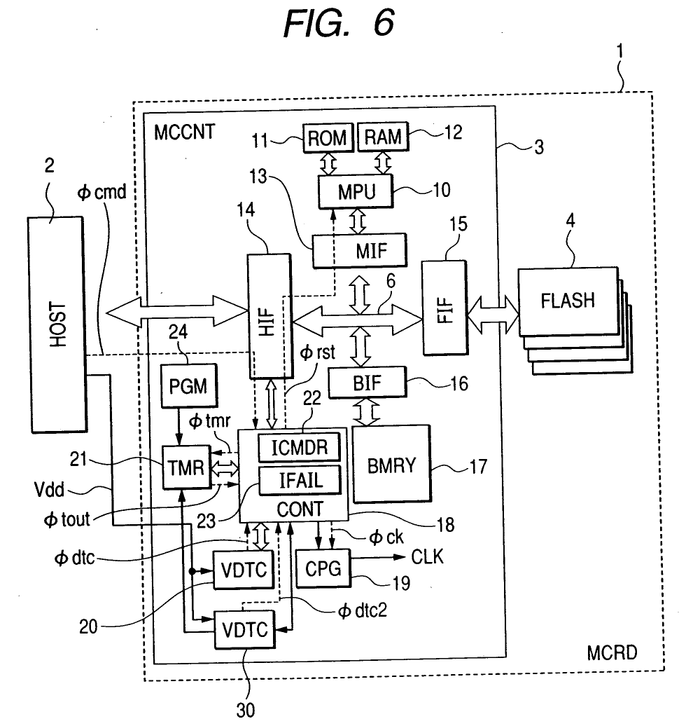

FIG. 6 shows a third example of a memory card. The configuration shown in FIG. 6 is equivalent to the configuration shown in FIG. 1 applied to a dual voltage memory card. This configuration includes a second voltage detection circuit 30 not included in the configuration shown in FIG. 1.

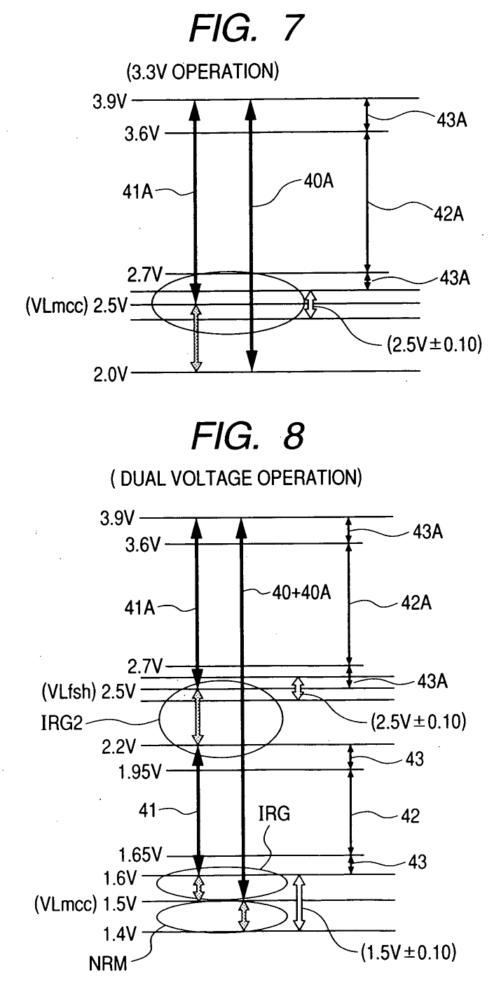

A dual voltage memory card 1 is compatible with two operating voltages, that is, 1.8 V nominal (low potential power supply) as indicated in FIG. 2 and 3.3 V nominal (high potential power supply) as indicated in FIG. 7.

Based on the assumption that the memory card is compatible with a supply voltage of 3.3 V nominal, reference numeral 40A in FIG. 7 denotes an operating voltage range (2.0 V to 3.9 V) of the memory card controller 3 and reference numeral 41A in FIG. 7 denotes an operating voltage range (2.5 V to 3.9 V) of the flash memory 4. A reason why the operating voltage ranges 40A and 41A are different is that the semiconductor manufacturing processes used to manufacture the memory card controller 3 and the flash memory 4 are different. The operating voltage range, subjected to no particular restrictions, recommended for the memory card 1, the supply voltage for which is 3.3 V nominal, is as denoted by reference numeral 42A (2.7 V to 3.6 V). Reference numeral 43A denotes marginal operating voltage ranges (1.0 V or more). In this arrangement, the voltage detection circuit 20 checks whether or not the supply voltage Vdd supplied from outside the memory card 1 is 2.5 V or more, that is, whether or not the Vdd is higher than the minimum voltage (VLfsh) of the voltage range 41A. This check is done with a voltage detection accuracy of ±0.10 V. When the supply voltage Vdd detected with the voltage detection accuracy is 2.5 V or more, the Vdd is already in the operating voltage range of the memory card 1. As long as the MPU 10 is made to execute the reset exception processing only after the Vdd has reached or exceeded 2.5 V, there is no fear of the MPU 10 going out of control because of an excessively low supply voltage.

An actual configuration of the dual voltage memory card 1 may be one in which, when using a high potential power supply, the supply voltage is lowered using a voltage regulator so as to make the card controller operate in the same voltage range as when using a low potential power supply, or it may be one in which the withstand voltage of the card controller is high enough to allow the card controller to operate using whichever of the low potential and high potential power supplies. In the former case, circuit portions to operate while being directly subjected to the supply voltage Vdd, for example, the input circuit for the supply voltage Vdd and the voltage detection circuits 20 and 30 are required to withstand a high voltage. No matter which of the low potential and high potential power supplies is used, the flash memory 4 requires a voltage boosting operation to obtain a high voltage required for write and erase operations, so that the supply voltage Vdd supplied from outside is supplied, as it is, to the flash memory. Therefore, the flash memory is provided with functions for being compatible with dual voltage power supply. It can, for example, determine whether the supply voltage is of a low potential or of a high potential and change the voltage boosting ratio as required. The voltage detection circuit 30 checks whether or not the supply voltage Vdd has exceeded the voltage VLfsh. When the voltage VLfsh has been exceeded, the voltage detection circuit 30 asserts the detection signal φdtc2 and supplies it to the external interface control circuit 18. When the detection signal φdtc2 is asserted, the external interface control circuit 18 enables a level conversion function of the FIF 15 so that the flash memory 4 is allowed to operate using the high potential power supply.

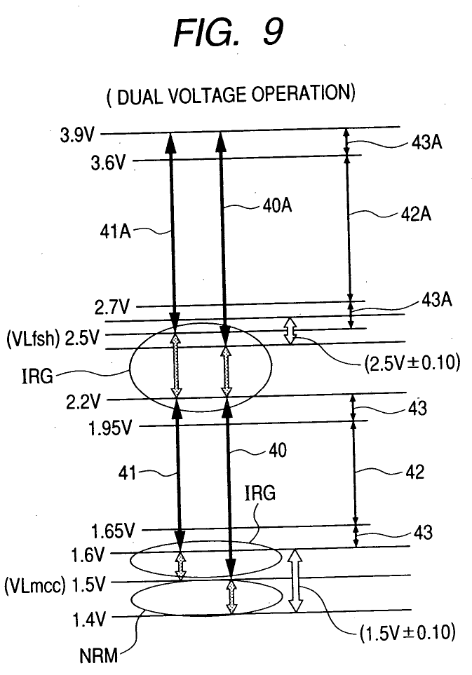

The supply voltage Vdd for the dual voltage memory card 1 ranges as shown in FIG. 8 or FIG. 9. The range of the supply voltage Vdd shown in FIG. 8 covers the range shown in FIG. 2 and the range shown in FIG. 7 combined. Namely, the MPU 10 has an operating supply voltage range fully covering the voltage range 40 shown in FIG. 2 and the voltage range 40A shown in FIG. 7. FIG. 9 shows an operating voltage range of 2.6 V to 3.9 V for when the high potential power supply is used in a circuit configuration in which the memory card controller 3 is operated using an internal power supply generated by lowering the voltage of the high potential power supply by use of a voltage regulator. In such an arrangement, when performance of the voltage regulator is taken into consideration, there will be a voltage range portion for which voltage lowering operation of the voltage regulator may be unstable. The above operating voltage range is a result of excluding such a voltage range portion. If the voltage regulator can stably operate in a full voltage range, the operating voltage range may be the same as the supply voltage range shown in FIG. 8. In FIGS. 8 and 9, IRG2 denotes a voltage range in which an error occurs at least in operation of the flash memory 3.

The power-on reset processing performed in the dual voltage memory card 1 is the same as described in the foregoing. When the configuration shown in FIG. 6 is used, the power-on reset processing may be the same as performed in the configuration shown in FIG. 1. For the dual voltage memory card 1, too, the configuration shown in FIG. 4 or FIG. 5 can be used as far as the power-on reset processing is concerned.

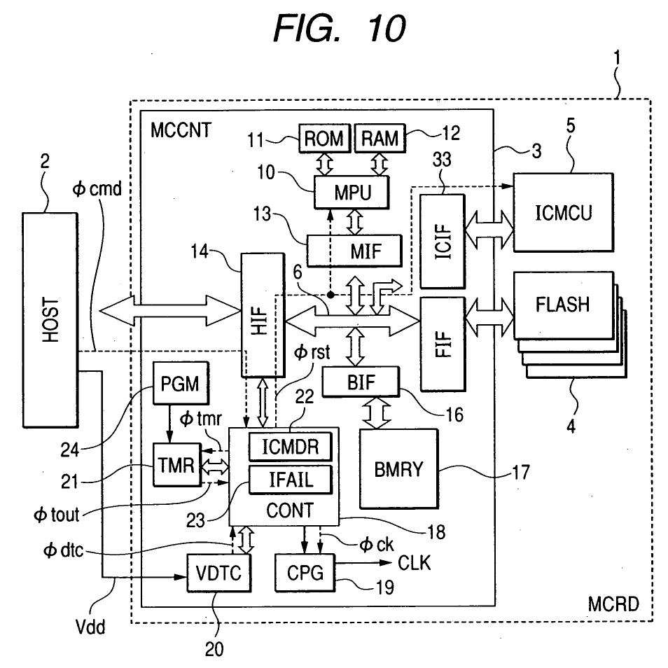

FIG. 10 shows a fifth example of a memory card. The configuration shown in FIG. 10 is basically the same as the configuration shown in FIG. 1, but it includes a microcomputer 5 for IC card which is connected to the bus 6 via a special interface circuit (ICIF) 33. External terminals of the microcomputer 5 for IC card and the electrical signal protocol and commands used by the microcomputer 5 for IC card comply with the ISO/IEC7816 standard. The external terminals of the microcomputer 5 for IC card include a power supply terminal 20, a clock input terminal 21, a reset terminal, an input/output terminal 23, and a ground terminal. The ICIF 33 supplies an IC card command supplied, concomitantly with a memory card command, from the host device 2 to the microcomputer 5 for IC card, thereby controlling operation thereof. The microcomputer 5 for IC card has, though not shown in the figure, a CPU (microcomputer) for performing arithmetic processing, ROM, RAM and EEPROM (Electrically Erasable Programmable ROM) for storing data (including programs), a code coprocessor composing a cipher device to perform encryption/decryption processing, and a serial interface for sending and receiving data to and from external devices. It is desirable that the microcomputer 5 for IC card be a product certified by an evaluation and certification organization for the ISO/IEC15408 that is an international security evaluation criteria standard. Generally, an IC card which has a security processing function and which is to be used in an electronic settlement service system is required to be evaluated and certified by an evaluation and certification organization for the ISO/IEC15408. To use the memory card 1 provided with a security processing function in an electronic settlement service system, the memory card 1 is required to be evaluated and certified by an evaluation and certification organization for the ISO/IEC15408. In cases where the microcomputer 5 for IC card has been certified by such an evaluation and certification organization, the microcomputer 5 can obtain a security processing function by incorporating the microcomputer 5 for IC card and a configuration for performing security processing making use of the microcomputer 5 for IC card. Thus, the memory card 1 can easily meet the security evaluation criteria based on the ISO/IEC15408, and the development time required to additionally provide the MMC with a security processing function can be reduced. This, however, does not exclude the use of the microcomputer 5 for IC card composed of a product not certified by an evaluation and certification organization for the ISO/IEC15408. The microcomputer 5 for IC card that has security strength required by a service to be offered making use of the microcomputer 5 for IC card may be used. Take an electronic settlement service based on prepaid cards, for example. Use of an IC card not evaluated and certified for the ISO/IEC15408 may be allowed for settlement up to a prepaid amount. To initialize the microcomputer 5 for IC card, the reset signal φrst may be supplied to it as done for the MPU 10. The microcomputer 5 for IC card is, however, designed to be resettable using an IC card command.

The present invention has been concretely described with respect to preferred embodiments. The present invention, however, is not limited to the above embodiments. Various changes and modifications may be made without departing from the spirit and scope of the invention.

For example, the conditions for responding again to the initialization command from the host device and having the reset exception processing started are not limited to a time-out detected by the timer circuit 21 and a data disagreement detected by the decision circuit 31. An occurrence, for example, of a state in which the data processing section has become or is anticipated to become out of control during the reset exception processing may also be used as one of such conditions.

The memory to be employed as a memory card is not limited to a flash memory. It may be, for example, an EEPROM or a mask ROM. The application of the present invention is not limited to a combination of a memory card controller and memory. It can also be applied, for example, to a nonvolatile storage apparatus incorporating a controller which has a data processing section capable of executing instructions and an external interface section, and a device to be controlled by the controller. The present invention can also be applied to a semiconductor device such as a controller having a data processing section capable of executing instructions and an external interface section.

1. A nonvolatile storage apparatus, comprising;
a first semiconductor device having a data processing section capable of executing instructions and an external interface section, and
a second semiconductor device controlled by the first semiconductor device,
wherein the external interface section, upon detecting that an operating supply voltage supplied from outside the nonvolatile storage apparatus has reached or exceeded a prescribed voltage, responds to an initialization command supplied from outside the nonvolatile storage apparatus and makes the data processing section start reset exception processing,
wherein, after the reset exception processing is completed, the external interface section does not respond to the initialization command, and
wherein, when a prescribed state is reached during the reset exception processing, the external interface section again responds to the initialization command and makes the data processing section start the reset exception processing.

2. The nonvolatile storage apparatus according to claim 1,
wherein the prescribed state is a state in which, during the reset exception processing, the data processing section has become or is anticipated to become out of control.

3. The nonvolatile storage apparatus according to claim 1,
wherein the external interface section has a timer circuit,
wherein the timer circuit starts counting in synchronization with starting of the reset exception processing and detects an elapse of a time-out period longer than a time required to complete the reset exception processing, and
wherein, when an elapse of the time-out period is detected by the timer circuit, the external interface section again responds to the initialization command and causes the reset exception processing to be started.

4. The nonvolatile storage apparatus according to claim 3, further comprising a specified circuit which includes programmed information for specifying a time-out period of the timer circuit.

5. The nonvolatile storage apparatus according to claim 1,
wherein the data processing section has a data processor, a ROM, and a decision circuit,
wherein the ROM holds a program for the reset exception processing,
wherein the decision circuit can detect, at least within a time required to complete the reset exception processing, disagreement between information read out from a prescribed address of the ROM and an anticipated value, and
wherein, when the disagreement is detected, the external interface section again responds to the initialization command and causes the reset exception processing to be started.

6. The nonvolatile storage apparatus according to claim 1,
wherein the external interface section has a timer circuit,
wherein the timer circuit starts counting in synchronization with starting of the reset exception processing and detects an elapse of a time-out period longer than a time required to complete the reset exception processing,
wherein the data processing section has a data processor, a ROM, and a decision circuit,
wherein the ROM holds a program for the reset exception processing,
wherein the decision circuit can detect, at least within a time required to complete the reset exception processing, disagreement between information read out from a prescribed address of the ROM and an anticipated value, and
wherein, when the elapse of the time-out period is detected by the timer circuit or when the disagreement is detected by the decision circuit, the external interface section again responds to the initialization command and causes the reset exception processing to be started.

7. The nonvolatile storage apparatus according to claim 1, further comprising;
a first flag which is changed from a first state to a second state when the initialization command supplied from outside the nonvolatile storage apparatus is received for the first time after the operating supply voltage supplied from outside the nonvolatile storage apparatus has reached or exceeded a prescribed voltage, and
a second flag which is changed from a first state to a second state when the prescribed state is reached during the reset exception processing and which is changed from the second state to the first state when the reset exception processing is subsequently completed,
wherein the external interface section, when both the first flag and the second flag are in the first state or when both the first flag and the second flag are in the second state, responds to the initialization command and makes the data processing section start the reset exception processing, and
wherein the external interface section, when the first flag is in the second state and the second flag is in the first state, does not allow the data processing section to start the reset exception processing even if the initialization command is given.

8. The nonvolatile storage apparatus according to claim 1,
wherein the second semiconductor device is a flash memory, and
wherein the first semiconductor device is a memory card controller which performs access control and external interface control for the flash memory.

9. The nonvolatile storage apparatus according to claim 8, having a microcomputer for IC card connected to the memory card controller.

10. A nonvolatile storage apparatus, comprising a first semiconductor device and a second semiconductor device controlled by the first semiconductor device,
wherein the first semiconductor device, upon detecting that an operating supply voltage supplied from outside has reached or exceeded a prescribed voltage, responds to an initialization command supplied from outside and starts reset exception processing,
wherein, after the reset exception processing is completed, the first semiconductor device does not respond to the initialization command, and
wherein, when a prescribed amount of time has elapsed after the reset exception processing was started, the first semiconductor device again responds to the initialization command and starts the reset exception processing.

11. A nonvolatile storage apparatus, comprising a first semiconductor device and a second semiconductor device controlled by the first semiconductor device,
wherein the first semiconductor device, upon detecting that an operating supply voltage supplied from outside has reached or exceeded a prescribed voltage, responds to an initialization command supplied from outside and starts reset exception processing,
wherein, after the reset exception processing is completed, the first semiconductor device does not respond to the initialization command, and
wherein, when a read access error is detected in making a read access to a memory storing a program for the reset exception processing before the reset exception processing is completed, the first semiconductor device again responds to the initialization command and starts the reset exception processing.

12. The nonvolatile storage apparatus according to claim 10,
wherein the second semiconductor device is a flash memory, and
wherein the first semiconductor device is a memory card controller which performs access control and external interface control for the flash memory.

13. A nonvolatile storage apparatus, comprising a first semiconductor device having a data processing section and a second semiconductor device controlled by the first semiconductor device,
wherein the first semiconductor device, upon detecting that an operating supply voltage supplied from outside is not lower than a prescribed voltage, responds to an initialization command supplied from outside and starts reset exception processing by the data processing section,
wherein, after the reset exception processing is completed, the first semiconductor device does not respond to the initialization command, and
wherein, when a state in which the data processing section has become or is anticipated to become out of control is reached during the reset exception processing, the first semiconductor device again responds to the initialization command and starts the reset exception processing by the data processing section.

14. A semiconductor device, comprising a data processing section capable of executing instructions and an external interface section, the semiconductor device being formed over a semiconductor substrate,
wherein the semiconductor device, upon detecting that an operating supply voltage supplied from outside has reached or exceeded a prescribed voltage, responds to an initialization command supplied from outside and starts reset exception processing by the data processing section,
wherein, after the reset exception processing is completed, the semiconductor device does not respond to the initialization command, and
wherein, when the reset exception processing has not been completed with a prescribed amount of time having elapsed after the reset exception processing was started, the semiconductor device again responds to the initialization command and starts the reset exception processing by the data processing section.

15. A semiconductor device, comprising a data processing section capable of executing instructions and an external interface section, the semiconductor device being formed over a semiconductor substrate,
wherein the semiconductor device, upon detecting that an operating supply voltage supplied from outside has reached or exceeded a prescribed voltage, responds to an initialization command supplied from outside and starts reset exception processing by the data processing section,
wherein, after the reset exception processing is completed, the semiconductor device does not respond to the initialization command, and
wherein, when a state in which the data processing section has become or is anticipated to become out of control is reached during the reset exception processing, the semiconductor device again responds to the initialization command and starts the reset exception processing by the data processing section.

16. The nonvolatile storage apparatus according to claim 11,
wherein the second semiconductor device is a flash memory, and
wherein the first semiconductor device is a memory card controller which performs access control and external interface control for the flash memory.
